(19) United States
(12) Patent Application Publication
(10) Pub. No.: US 2016/0126800 A1
(43) Pub. Date: May 5, 2016

(54) ELECTRIC DRIVE UNIT

(71) Applicant: AUDI AG, Ingolstadt (DE)

(72) Inventor: JOSEF RUSCH, Grossmehring (DE)

(73) Assignee: AUDI AG, Ingolstadt (DE)

(21) Appl. No.: 14/930,085

(22) Filed: Nov. 2, 2015

(30) Foreign Application Priority Data
Nov. 3, 2014 (DE) 10 2014 016 171.4

(51) Int. Cl. H02K 5/20; H02K 9/22; H02K 11/00; H02K 9/00

(52) U.S. Cl. CPC H02K 5/20; H02K 9/005; H02K 9/22; H02K 11/0073

(57) ABSTRACT

An electric drive unit includes an electric motor having a motor housing which has at least one coolant channel for cooling the electric motor. A power electronic device operates the electric motor and includes an electronic housing having a contact surface which is connected to a mating contact surface of the motor housing. The power electronic device is hereby configured in the absence of a coolant channel and connected to the motor housing in a heat-transferring manner.

### CROSS-REFERENCES TO RELATED APPLICATIONS

This application claims the priority of German Patent Application, Serial No. 10 2014 016 171.4, filed Nov. 3, 2014, pursuant to 35 U.S.C. 119(a)-(d), the disclosure of which is incorporated herein by reference in its entirety as if fully set forth herein.

### BACKGROUND OF THE INVENTION

The present invention relates to an electric drive unit.

The following discussion of related art is provided to assist the reader in understanding the advantages of the invention, and is not to be construed as an admission that this related art is prior art to this invention.

An electric drive unit may be used for example to operate a motor vehicle in order to provide a torque for powering the motor vehicle. For this purpose, the electric drive unit has an electric motor having a driveshaft which is operably connected to an input shaft of a gearbox of the motor vehicle. The electric motor is typically activated by a power electronic device which has at least one structural part, e.g. a power transistor or power MOSFET. Oftentimes, the power electronic device includes an inverter to convert direct current, provided by the on-board power supply of the motor vehicle, into alternating current for operating the electric motor. Typically, the electric motor is therefore configured as AC motor or three-phase motor.

As the electric drive unit normally yields a relatively high maximum power, the provision of a cooling of the electric motor is required. For that purpose, the electric motor has a motor housing formed with a cooling channel which can be part of a cooling circuit of the electric drive unit and in which coolant is circulated by a coolant pump for example to dissipate heat generated in the electric motor.

It would be desirable and advantageous to provide an improved electric drive unit which obviates prior art shortcomings and which is simple in structure and cost-effective while yet being reliable in operation and operating at high power.

### SUMMARY OF THE INVENTION

According to one aspect of the present invention, an electric drive unit includes an electric motor having a motor housing with at least one coolant channel for cooling the electric motor, and a power electronic device configured to operate the electric motor and including an electronic housing having a contact surface connected to a mating contact surface of the motor housing, the power electronic device being configured in the absence of a coolant channel and connected to the motor housing in a heat-transferring manner.

As described above, when the electric motor runs at maximum power, a high heat amount is generated. The same applies for the power electronic device that activates the electric motor. For that reason, there is need for cooling the power electronic device in addition to the electric motor. While this can be realized, for example, by providing in the power electronic device, especially in the electronic housing thereof, at least one coolant channel for circulation of a coolant, in addition to the coolant channel in the motor housing. This approach, however, is not only complex and cost-intensive but requires also large installation space in order to be able to provide the coolant channel in the power electronic device. The inventor has now surprisingly recognized that a cooling of the power electronic device is feasible, even though it lacks the provision of a separate coolant channel, by connecting the power electronic device with the motor housing in a heat-transferring manner. In this way, heat generated in the power electronic device can be dissipated to the motor housing from where heat can easily be dissipated subsequently, especially by coolant circulating in the coolant circuit of the motor housing.

The heat-transfer connection between the power electronic device and the motor housing can be realized by providing the electronic housing with a contact surface which complements the mating contact surface of the motor housing. Advantageously, both the contact surface of the power electronic device and the mating contact surface of the motor housing have a planar configuration, i.e. are basically flat except for inherent surface roughness. The contact surface of the power electronic device bears flatly or planar upon the mating contact surface of the motor housing, or is at least connected with the mating contact surface of the motor housing in a heat-transferring manner. As a result, a comparably large contact area is realized via which heat from the power electronic device can be transferred onto the motor housing. The power electronic device can thus be built small and cost-effectively in view of the absence of a coolant channel formed therein. Therefore, there is also no need to seal a coolant channel against the power electronic device.

According to another advantageous feature of the present invention, a heat-conducting element can be arranged between the contact surface of the electronic housing and the mating contact surface of the motor housing. The heat-conducting element may hereby have at least one area arranged between the contact surface of the electronic housing and the mating contact surface of the motor housing, or be arranged entirely between the contact surface of the electronic housing and the mating contact surface of the motor housing. The heat-conducting element hereby improves heat transfer from the power electronic device to the motor housing. The heat-conducting element is suitably made of a material having a high thermal conductivity coefficient or at least promoting the efficiency of the heat-transfer connection between the power electronic device and the motor housing. As described above, the heat-conducting element can have at least one area disposed between the contact surface of the electronic housing and the mating contact surface of the motor housing, or advantageously covers at least the contact surface of the electronic housing across the entire surface thereof. Currently preferred is the disposition of the heat-conducting element such as to cover both the entire contact surface of the electronic housing and the entire mating contact surface of the motor housing.

According to another advantageous feature of the present invention, the heat-conducting element can be configured as a heat-conducting film or heat-conducting adhesive. The heat-conducting film may be made, for example, of elastomer, such as silicone elastomer. The elastomer may be reinforced by a fabric, e.g. glass fabric. The material of the heat-conducting film may also contain at least one additive that improves heat conductivity of the heat-conducting film. Examples of an additive include aluminum, copper, graphite and/or silver. When made of heat-conducting adhesive, the heat-conducting element not only assumes the task of heat transfer but also assumes a fastening function. As a result, use of heat-conducting adhesive enables a securement of the power electronic device upon the motor housing of the electric motor. The heat-conducting adhesive may be made of a same material as the heat-conducting film.

According to another advantageous feature of the present invention, the electronic housing can be mounted to the motor housing by at least one screw connection and/or by a material joint via the heat-conducting element. The electronic housing may be secured at any location to the motor housing so long as the contact surface of the electronic housing is connected to, advantageously flatly bearing upon, the mating contact surface of the motor housing. Currently preferred is, however, a form fit and/or interference fit, using a screw connection for example. In addition, or as an alternative, the electronic housing may be secured to the motor housing by the heat-conducting element. For that purpose, the heat-conducting element is configured as a self-adhesive heat-conducting film or heat-conducting adhesive.

According to another advantageous feature of the present invention, the electric motor can have at least one electric terminal sized to extend through the heat-conducting element. The power electronic device and the motor housing adjoin one another in the region of the contact surface and the mating contact surface. As a result, the path through the heat-conducting element represents a shortest connection between the power electronic device and the electric motor. Likewise, the electric terminal, e.g. in the form of a conductor or a conductor path, traverses the heat-conducting element. For this purpose, provision may be made for an opening in the heat-conducting element which opening has a closed edge and thus does noₜ extend through side faces of the heat-conducting element. Currently preferred is the provision of several electric terminals, especially an electric terminal for each phase of the electric motor.

According to another advantageous feature of the present invention, the motor housing can have a motor flange, with the mating contact surface being part of the motor flange. The presence of the motor flange ensures a reliable securement of the power electronic device upon the electric motor. The motor flange is thus sized to extend from the motor housing in the direction of the power electronic device. Whereas further regions of the motor housing may be substantially of round configuration, the motor flange can advantageously be made of rectangular configuration. The rectangular configuration of the motor flange establishes the planar mating contact surface of the motor housing.

According to another advantageous feature of the present invention, the coolant channel can be arranged in relation to the mating contact surface of the motor housing at a distance which in relation to a diameter of the coolant channel is smaller than 1, or smaller than 0.75, or smaller than 0.5, or smaller than 0.25. To realize adequate cooling of the power electronic device by coolant flowing in the coolant channel, provision is made to place the coolant channel of the motor housing in the region of the power electronic device and thus in the region of the mating contact surface. Advantageously, the coolant channel is sized to extend through the motor flange or into the motor flange. The coolant channel has at least at one point where the coolant channel has the afore-mentioned distance, which is related to the diameter of the cooling channel. In other words, the distance of the cooling channel from the mating contact surface is at a maximum as great as the diameter thereof, preferably however smaller. Currently preferred is an arrangement of the coolant channel, at least in part, in parallel relation to the mating contact surface. Advantageously, the coolant channel has hereby the afore-mentioned distance.

According to another advantageous feature of the present invention, the electric motor has a rotor, with the coolant channel being configured to have at least one area which embraces the rotor in relation to a rotation axis of the rotor. Advantageously, the coolant channel can be configured to embrace the rotor in relation to a rotation axis of the rotor in its entirety. The electric motor normally includes a stator besides the rotor, with the rotor being operably connected, in particular rigidly and/or permanently, to the driveshaft of the electric motor. The rotor rotates about the rotation axis during operation of the electric motor. The coolant channel in the motor housing is configured to embrace the rotor and/or the stator of the electric motor in circumferential direction in relation to the rotation axis, at least in part. Currently preferred is a configuration in which the coolant channel embraces the rotor and the stator in their entirety in circumferential direction so as to evenly cool the electric motor.

According to another advantageous feature of the present invention, the contact surface of the electronic housing can be a side face of the electronic housing. Advantageously, the contact surface corresponds to the entire side face of the electronic housing. The electronic housing may hereby have a substantially block-shaped configuration, i.e. is rectangular in cross section. Such a configuration of the electronic housing results in a very large effective area that is available as contact surface for a heat transfer from the power electronic device onto the motor housing.

### BRIEF DESCRIPTION OF THE DRAWING

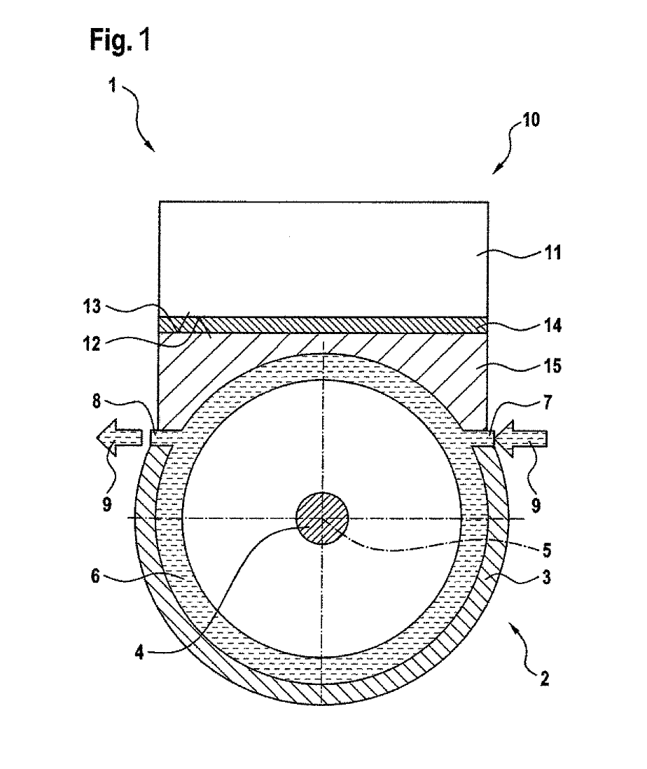

Other features and advantages of the present invention will be more readily apparent upon reading the following description of currently preferred exemplified embodiments of the invention with reference to the accompanying drawing, in which the sole FIG. 1 is a schematic cross sectional view of an electric drive unit according to the present invention.

### DETAILED DESCRIPTION OF PREFERRED EMBODIMENTS

The depicted embodiment is to be understood as illustrative of the invention and not as limiting in any way. It should also be understood that the figure is not necessarily to scale and that the embodiment may be illustrated by graphic symbols, phantom lines, diagrammatic representations and fragmentary views. In certain instances, details which are not necessary for an understanding of the present invention or which render other details difficult to perceive may have been omitted.

Turning now to FIG. 1, there is shown a schematic cross sectional view of an electric drive unit according to the present invention, generally designated by reference numeral 1 and applicable for example for powering a motor vehicle. The drive unit 1 includes an electric motor 2 which has a motor housing 3. Arranged inside the motor housing 3 is a rotor of the electric motor 2. The rotor is not shown here for sake of simplicity and is operably connected, advantageously rigidly and/or permanently, with a driveshaft 4 of the electric motor 2. The driveshaft 4 and thus the rotor have a common rotation axis 5. The motor housing 3 has formed therein at least one coolant channel 6 which can be supplied with coolant from a coolant port 7 and discharges coolant via a coolant port 8. This is indicated by arrows 9. The coolant channel 6 is configured to advantageously embrace the rotor of the electric motor 2 in its entirety in circumferential direction in relation to the rotation axis 5, as shown in FIG. 1.

In addition to the electric motor 2, the drive unit 1 includes a power electronic device 10, which includes an electronic housing 11 and at least one power electronic element arranged inside the electronic housing 11. The electronic housing 11 has a contact surface 12 which bears flatly upon a mating contact surface 13 of the motor housing 3. The contact surface 12 is in heat-transfer connection with the mating contact surface 13 or is connected therewith. For this purpose, the contact surface 12 either directly bears upon the mating contact surface 13 or, as an alternative, provision may also be made for a heat-conducting element 14 arranged between the contact surface 12 and the mating contact surface 13, as shown in FIG. 1. The heat-conducting element 14 may be realized in the form of a heat-conducting film, as indicated in FIG. 1. The contact surface 12 advantageously corresponds to a side face of the electronic housing 11 which can have a generally block-shaped or cuboid configuration. The contact surface 12 corresponds hereby for example to the greatest side face of the electronic housing 11.

The mating contact surface 13 of the motor housing 2 can be established by a motor flange 15 which, for example, may have same outer dimensions as the electronic housing 11. Thus, the electronic housing 11 is flush-mounted to the motor flange 15, after installation to the electric motor 2. The electronic housing 11 is devoid of any coolant channel so that no coolant needs to be supplied to the power electronic device 10. Rather, the connection between the contact surface 12 with the mating contact surface 12 establishes a heat-transfer connection between the power electronic device 10 and the motor housing 3. As a result, heat generated by the power electronic device 10 can be dissipated by coolant circulating in the coolant channel 6 of the motor housing 3. Thus, the drive unit 1 can have a very compact and cost-effective configuration.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. An electric drive unit, comprising:
an electric motor including a motor housing having at least one coolant channel for cooling the electric motor; and
a power electronic device configured to operate the electric motor and including an electronic housing having a contact surface connected to a mating contact surface of the motor housing, said power electronic device being configured in the absence of a coolant channel and connected to the motor housing in a heat-transferring manner.

2. The electric drive unit of claim 1, further comprising a heat-conducting element arranged between the contact surface of the electronic housing and the mating contact surface of the motor housing.

3. The electric drive unit of claim 2, wherein the heat-conducting element has at least one area arranged between the contact surface of the electronic housing and the mating contact surface of the motor housing.

4. The electric drive unit of claim 2, wherein the heat-conducting element is arranged entirely between the contact surface of the electronic housing and the mating contact surface of the motor housing.

5. The electric drive unit of claim 2, wherein the heat-conducting element is configured as a heat-conducting film or heat-conducting adhesive.

6. The electric drive unit of claim 2, wherein the electronic housing is mounted to the motor housing by at least one screw connection and/or by a material joint via the heat-conducting element.

7. The electric drive unit of claim 2, wherein the electric motor has at least one electric terminal sized to extend through the heat-conducting element.

8. The electric drive unit of claim 1, wherein the motor housing has a motor flange, said mating contact surface being part of the motor flange.

9. The electric drive unit of claim 8, wherein the coolant channel is configured to extend through the motor flange.

10. The electric drive unit of claim 1, wherein the coolant channel is arranged in relation to the mating contact surface of the motor housing at a distance which in relation to a diameter of the coolant channel is smaller than 1.

11. The electric drive unit of claim 1, wherein the coolant channel is arranged in relation to the mating contact surface of the motor housing at a distance which in relation to a diameter of the coolant channel is smaller than 0.75.

12. The electric drive unit of claim 1, wherein the coolant channel is arranged in relation to the mating contact surface of the motor housing at a distance which in relation to a diameter of the coolant channel is smaller than 0.5.

13. The electric drive unit of claim 1, wherein the coolant channel is arranged in relation to the mating contact surface of the motor housing at a distance which in relation to a diameter of the coolant channel is smaller than 0.25.

14. The electric drive unit of claim 1, wherein the electric motor has a rotor, said coolant channel being configured to have at least one area which embraces the rotor in relation to a rotation axis of the rotor.

15. The electric drive unit of claim 1, wherein the electric motor has a rotor, said coolant channel being configured to embrace the rotor in relation to a rotation axis of the rotor in its entirety.

16. The electric drive unit of claim 1, wherein the contact surface of the electronic housing is a side surface of the electronic housing.
